(19) United States
(12) Patent Application Publication
(10) Pub. No.: US 2004/0163690 A1
(43) Pub. Date: Aug. 26, 2004

(54) Filter assembly of dishwasher

(76) Inventor: Yong Hee Kim, Changwon-si (KR)

Correspondence Address: FLESHNER & KIM, LLP, P.O. BOX 221200, CHANTILLY, VA, 20153, US

(21) Appl. No.: 10/721,736

(22) Filed: Nov. 26, 2003

(30) Foreign Application Priority Data
Nov. 28, 2002 (KR) P2002-0074989

(51) Int. Cl. B08B 3/02

(52) U.S. Cl. 134/104.1; 134/111; 134/110; 134/186

(57) ABSTRACT

A filter assembly having a plurality of concentric filters for use in a dishwasher prevents an undue accumulation of waste particles in the outer filter by periodically spraying water into the filter assembly. The filter assembly includes a water circulator for supplying washing and rinsing water under pressure to the filter assembly; and at least one cleaning nozzle, provided at a predetermined position along an outer circumference of the filter assembly, to communicate with the water circulator. The pressurized water of the water circulator is sprayed into the filter assembly.

This application claims the benefit of Korean Application No. 10-2002-0074989 filed on Nov. 29, 2002, which is hereby incorporated by reference.

### BACKGROUND OF THE INVENTION

1. Field of the Invention

The present invention relates to a dishwasher, and more particularly, to a filter assembly employing a cleaning nozzle to clean the filters of a dishwasher.

2. Discussion of the Related Art

Referring to FIG. 1, a general dishwasher is comprised of a washtub 4, installed in a body 2 forming an exterior, for holding tableware and the like on a sliding rack 12; a sump 6, installed under the washtub, for collecting runoff water; a plurality of injection nozzles 14 for spraying water toward the rack from an injection passage 14a connected to the sump; a wash pump assembly 8, installed at one side of the sump, for circulating water using a wash pump 8b connected to a pump body 8a; a drain pump assembly 10, installed at the other side of the sump, for draining the water; and a filter assembly 20, installed in a filter holder 6a provided at a center of the sump, for filtering waste particles from the water before draining or re-circulating.

The filter assembly 20 includes a series of concentrically first, second, and third filters 22, 24, and 26, each of which is provided with a progressively larger receptacle for fitting one into the other. Accordingly, as the circulating water passes through the filters 22, 24, and 26, large waste particles are filtered prior to smaller particles. After using the dishwasher, a user manually removes from the filters 22, 24, and 26 the waste filtered by the filter assembly 20.

In the above dishwasher using a filter assembly according to the related art, however, minute particles of waste tend to accumulate on the outer filter 26, to block the filters and impede water circulation accordingly. A reduction of water circulation degrades washing performance, and a complete blockage will preclude operation and force the user to clean the filters manually.

### SUMMARY OF THE INVENTION

Accordingly, the present invention is directed to a filter assembly of a dishwasher that substantially obviates one or more of the problems due to limitations and disadvantages of the related art.

An object of the present invention, which has been devised to solve the foregoing problem, lies in providing a filter assembly of a dishwasher, by which the undue accumulation of waste particles filtered from circulating water is prevented by periodically spraying water directly into the filter assembly.

It is another object of the present invention to provide a filter assembly of a dishwasher, which facilitates water circulation to improve wash performance.

It is another object of the present invention to provide a filter assembly of a dishwasher, which reduces the need for the filters of the filter assembly to be cleaned manually.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a filter assembly for filtering waste particles in a dishwasher. The filter assembly comprises water circulating means for supplying washing and rinsing water under pressure to the filter assembly; and at least one cleaning nozzle, provided at a predetermined position along an outer circumference of the filter assembly, to communicate with the water circulating means, wherein the pressurized water of the water circulating means is sprayed into the filter assembly.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross-sectional view of a general dishwasher;

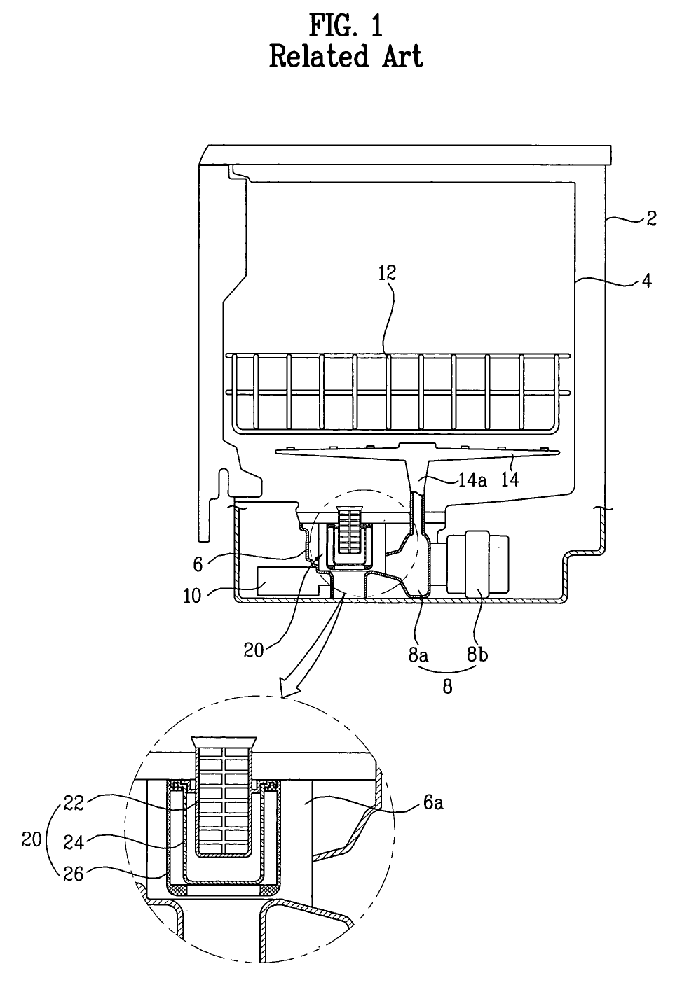

FIG. 2 is a cross-sectional view of a dishwasher adopting a filter assembly according to the present invention; and

FIG. 3 is a perspective breakaway view of an apparatus for cleaning filters in a dishwasher according to the present invention.

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations where possible.

The present invention is directed towards the filter assembly for filtering waste particles in a dishwasher. The filter assembly is comprised of series of concentrically arranged filters having varyingly sized filter holes, respectively, wherein the outer filter of the filter assembly has the smallest holes.

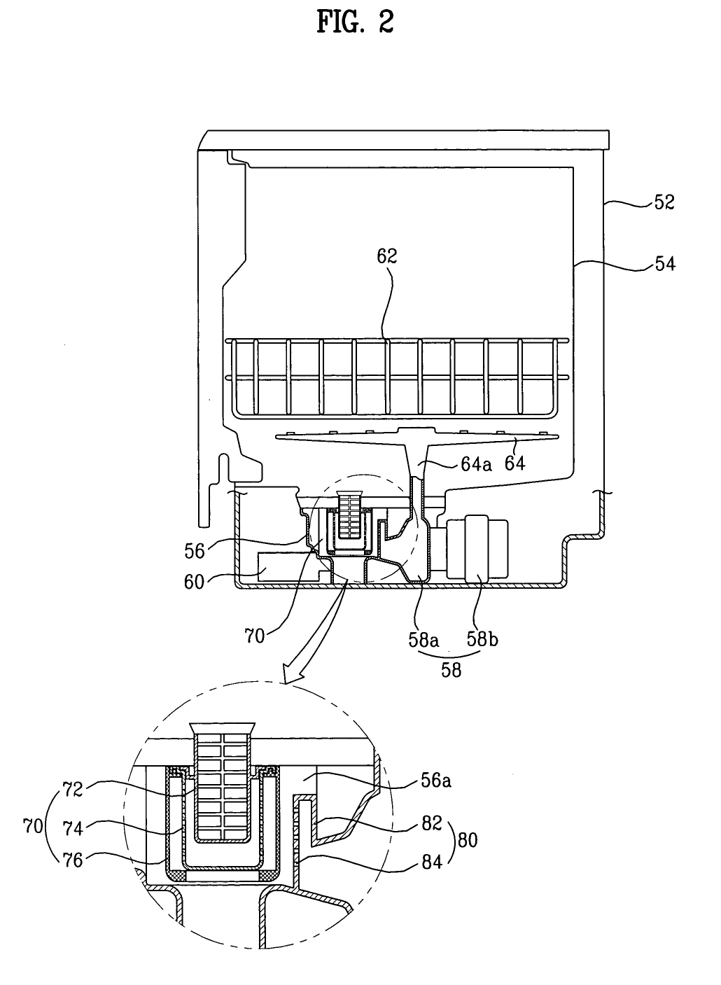

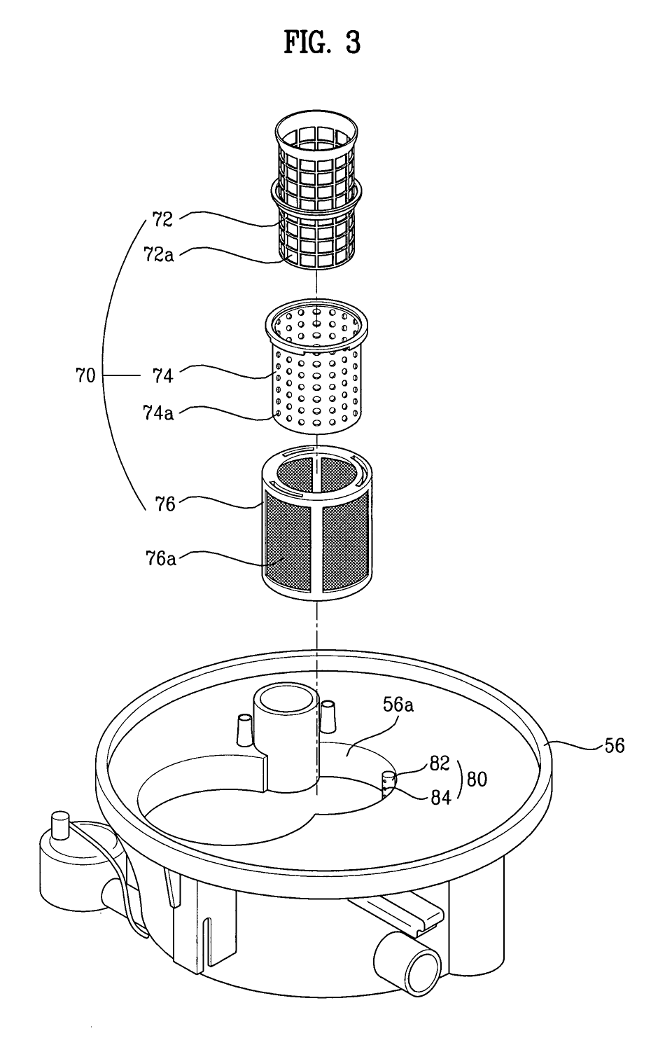

Referring to FIGS. 2 and 3, a dishwasher adopting a filter assembly according to the present invention is comprised of a washtub 54, installed in a body 52 forming an exterior, for holding tableware and the like on a sliding rack 62; a sump 56, installed under the washtub, for collecting runoff water; a plurality of injection nozzles 64 for spraying water toward the rack from an injection passage 64a connected to the sump; a wash pump assembly 58, installed at one side of the sump, for circulating water using a wash pump 58b connected to a pump body 58a; a drain pump assembly 60, installed at the other side of the sump, for draining the water; and a filter assembly 70, installed in a filter holder 56a provided at a center of the sump, for filtering waste particles from the water before draining or re-circulating.

The filter assembly 70 includes a series of concentrically arranged first, second, and third filters 72, 74, and 76, each of which is provided with a progressively larger receptacle for fitting one into the other. The first, second, and third filters 72, 74, and 76 are provided with a multitude of progressively smaller filter holes 72a, 74a, and 76a, respectively, to filter larger particles prior to smaller particles. The third filter 76 is fixed to the filter holder 56a of the sump 56, the second filter 74 is detachably installed in the third filter 76, and the first filter 72 is detachably installed in the second filter 74. Accordingly, large, medium-sized, and small waste particles are filtered by the first to third filters 72, 74, and 76, respectively, with the third filter filtering the most minute particles.

In addition, a cleaning nozzle 80 is installed adjacent the outer circumference of the third filter 76 of the filter assembly 70. The cleaning nozzle 80, which is thus juxtaposed to the third filter 76 having the smallest holes, comprises a cylindrical nozzle body 82 installed in the filter holder 56a of the sump 56, to communicate with a water supply valve assembly (not shown) and the wash pump assembly 58; and a multitude of injection holes 84 perforating in the nozzle body, so as to face the filter assembly 70. Accordingly, using the water from a water circulating means comprised of the sump 56, the water supply valve assembly, and the wash pump assembly 58, water is periodically upon the supply of water to the water circulating means sprayed through the injection holes 84 of the cleaning nozzle 80 directly into the filter assembly 70. Hydraulic pressure, provided by the water pump of the water circulating means, is used to clean the filter assembly whenever water is supplied for washing or rinsing. Thus, there is no need for a separate pressurizing device.

According to the present invention, a plurality of the cleaning nozzles 80, each having a number of injection holes formed at intervals in a nozzle body, are preferably formed at predetermined positions along the outer circumference of the filter assembly 70. The size of the resulting number of injection holes 84 is determined by the water pressure of a service pipe supplying the water circulating means.

In the operation of the dishwasher according to the present invention, with water supplied, the wash pump 58b is actuated to perform the washing of tableware placed in the rack 62, whereupon the water in the sump 56 is sprayed toward the rack via the injection passage 64a and the nozzles 64. The water thus circulates through the sump 56, injection passage 64a, nozzles 64, and washtub 54. Waste particles from the tableware are filtered from the circulating water in the filter assembly 70 installed in the sump 56, with filtering progressing as water circulates via the water circulating means. A similar process is executed for rinsing.

That is, during washing and rinsing, as water is supplied to the sump via the water supply valve, the water is sprayed via the cleaning nozzle 80 directly into the third (outer) filter 76, and indirectly into the second and first (inner) filters 74 and 72, whereby waste particles are filtered from the circulating water and the most minute particles of the third filter are cleaned periodically. Hence, the blocking of water circulation due to the accumulation of particles on the third filter 76 is prevented, to reduce the need for the filter to be cleaned manually. The spraying action of the cleaning nozzle 80 also reduces blockage in the filter holes 72a and 74a of the inner filters. Thus, water circulation is facilitated and wash performance is improved accordingly.

It will be apparent to those skilled in the art that various modifications and variations can be made in the present invention without departing from the spirit or scope of the invention. Thus, it is intended that the present invention cover such modifications and variations, provided they come within the scope of the appended claims and their equivalents.

What is claimed is:

1. A filter assembly for filtering waste particles in a dishwasher, the filter assembly comprising:
water circulating means for supplying washing and rinsing water under pressure to the filter assembly; and
at least one cleaning nozzle, provided at a predetermined position along an outer circumference of the filter assembly, to communicate with said water circulating means,
wherein the pressurized water of said water circulating means is sprayed into the filter assembly.

2. The filter assembly as claimed in claim 1, wherein said water circulating means comprises a wash pump assembly for circulating water and a sump for collecting runoff water.

3. The filter assembly as claimed in claim 1, wherein the filter assembly is comprised of a plurality of concentrically arranged filters and wherein said at least one cleaning nozzle is juxtaposed to an outer filter of the filter assembly.

4. The filter assembly as claimed in claim 3, wherein the filters of the filter assembly have varyingly sized filter holes, respectively, and wherein the outer filter of the filter assembly has the smallest holes among the varyingly sized holes.

5. The filter assembly as claimed in claim 1, wherein said at least one cleaning nozzle comprises a nozzle body and a multitude of injection holes perforating the nozzle body.

6. The filter assembly as claimed in claim 5, wherein the injection holes perforating the nozzle body each have a size determined by the water pressure of said water circulating means, wherein the water pressure of said water circulating means is derived from a service pipe.
